(19) United States
(12) Patent Application Publication
(10) Pub. No.: US 2026/0260467 A1
(43) Pub. Date: Sep. 3, 2026

(54) IMAGE PROCESSING DEVICE, IMAGE PROCESSING METHOD, IMAGE PROCESSING SYSTEM, AND PROGRAM

(71) Applicant: HONDA MOTOR CO., LTD., Minato-ku, Tokyo (JP)

(72) Inventor: Tokitomo Ariyoshi, Wako-shi (JP)

(21) Appl. No.: 18/878,682

(22) PCT Filed: Jun. 28, 2023
(86) PCT No.: PCT/JP2023/023923

§ 371 Date: Dec. 24, 2024

(30) Foreign Application Priority Data
Jun. 30, 2022 (JP) 2022-106667

(51) Int. Cl. G06V 10/774; G06F 21/62

(52) U.S. Cl. CPC G06V 10/774; G06F 21/6254

(57) ABSTRACT

An image processing device includes an acquisition unit configured to acquire a size of a face shown in an input image or a distance from a capturing point of the input image to the face and an image conversion unit configured to perform an anonymization process on the input image. The image conversion unit decides to perform the anonymization process based on a first method or the anonymization process based on a second method different from the first method on the face shown in the input image on the basis of the size or the distance.

### TECHNICAL FIELD

The present invention relates to an image processing device, an image processing method, an image processing system, and a program.

### BACKGROUND ART

In recent years, efforts to provide access to sustainable transportation systems have been increasingly active in consideration of vulnerable individuals among participants in transportation. In pursuit of this realization, research and development of automated driving technology is being emphasized to further improve the safety and convenience of transportation. For example, conventionally, technology for annotating an individual's face image to generate learning data for use in training a machine learning model is known. Patent Document 1 discloses technology for generating a synthetic face image with reference to face images of a plurality of persons stored in a face image database and enabling an annotation manipulation to be performed on the generated synthetic face image.

### CITATION LIST

### Patent Document

Patent Document 1: Japanese U.S. Pat. No. 5,930,450

### SUMMARY OF INVENTION

### Technical Problem

The technology described in Patent Document 1 protects the privacy of a plurality of persons when an annotator performs an annotation manipulation on a synthetic face image synthesized from face images of the plurality of persons. However, in the conventional technology, feature information of an original image may be missing due to a process of converting the original image to protect privacy. As a result, it may be difficult to generate learning data effective for training machine learning models while protecting the privacy of a person shown in a face image.

The present invention has been made in consideration of such circumstances and an objective of the present invention is to provide an image processing device, an image processing method, and a program for enabling learning data effective for training a machine learning model to be generated while protecting the privacy of a person shown in a face image. Thereby, the contribution to the development of a sustainable transportation system is improved.

### Solution to Problem

An image processing device, an image processing method, an image processing system, and a program according to the present invention adopt the following configurations.
(1): According to an aspect of the present invention, there is provided an image processing device including: an acquisition unit configured to acquire a size of a face shown in an input image or a distance from a capturing point of the input image to the face; and an image conversion unit configured to perform an anonymization process on the input image, wherein the image conversion unit decides to perform the anonymization process based on a first method or the anonymization process based on a second method different from the first method on the face shown in the input image on the basis of the size or the distance.
(2): In the above-described aspect (1), the image processing device further includes an image determination unit configured to determine whether or not the input image on which the anonymization process has been performed satisfies a predetermined requirement and perform a predetermined process on the input image on which the anonymization process has been performed when it is determined that the input image on which the anonymization process has been performed satisfies the predetermined requirement.
(3): In the above-described aspect (2), the predetermined process is a process of saving the input image on which the anonymization process has been performed as an annotation work target image.
(4): In the above-described aspect (2), the predetermined process is a process of saving the input image on which the anonymization process has been performed as learning information for generating a behavior prediction model for predicting behavior of a person shown in the input image.
(5): In the above-described aspect (2), the predetermined process is a process of transmitting the input image on which the anonymization process has been performed to an image server through a communication means.
(6): In the above-described aspect (1), the anonymization process based on the first method is a process of concealing a face shown in the input image and the anonymization process based on the second method is a process of changing a face of a person shown in the input image to a face of another person.
(7): In the above-described aspect (6), the acquisition unit further acquires direction information about the face of the person shown in the input image, and the image conversion unit performs the anonymization process based on the first method on the face of the person shown in the input image when the acquisition of the direction information by the acquisition unit has failed.
(8): In the above-described aspect (6), the acquisition unit further acquires direction information about the face of the person shown in the input image, and the image conversion unit performs the anonymization process based on the first method on the face of the person shown in the input image when the direction information about the face of the person shown in the input image is not consistent with direction information about the face of the person shown in the input image on which the anonymization process based on the second method has been performed.
(9): In the above-described aspect (6), the image conversion unit performs the anonymization process based on the second method on a plurality of input images captured in time series and performs the anonymization process based on the first method on a face of a person shown in the plurality of input images when the face of the person tracked as the same person in the plurality of input images is not the same face in the plurality of input images on which the anonymization process has been performed.
(10): In the above-described aspect (2), the image conversion unit performs the anonymization process based on the second method on the input image again when the image determination unit determines that the input image on which the anonymization process has been performed does not satisfy the predetermined requirement.
(11): In the above-described aspect (2), the image conversion unit does not perform the predetermined process on the input image on which the anonymization process has been performed when the image determination unit determines that the input image on which the anonymization process has been performed does not satisfy the predetermined requirement.
(12): In the above-described aspect (2), the predetermined requirement differs according to whether the input image is an image obtained by capturing an interior of a vehicle equipped with a camera that has captured the input image or an image obtained by capturing an exterior of the vehicle.
(13): According to another aspect of the present invention, there is provided an image processing system including: an acquisition unit configured to acquire a size of a face shown in an input image or a distance from a capturing point of the input image to the face; and an image conversion unit configured to perform an anonymization process on the input image, wherein the image conversion unit decides to perform the anonymization process based on a first method or the anonymization process based on a second method different from the first method on the face shown in the input image on the basis of the size or the distance.
(14): According to yet another aspect of the present invention, there is provided an image processing method including: acquiring, by a computer, a size of a face shown in an input image or a distance from a capturing point of the input image to the face; performing, by the computer, an anonymization process on the input image; and deciding, by the computer, to perform the anonymization process based on a first method or the anonymization process based on a second method different from the first method on the face shown in the input image on the basis of the size or the distance.
(15): According to yet another aspect of the present invention, there is provided a program for causing a computer to: acquire a size of a face shown in an input image or a distance from a capturing point of the input image to the face; perform an anonymization process on the input image; and decide to perform the anonymization process based on a first method or the anonymization process based on a second method different from the first method on the face shown in the input image on the basis of the size or the distance.

### Advantageous Effects of Invention

According to the aspects (1) to (15), it is possible to generate learning data effective for training a machine learning model while protecting the privacy of a person shown in a face image.

### BRIEF DESCRIPTION OF DRAWINGS

FIG. 1 A diagram showing an overview of a system 1 including an image processing device 100 according to the present embodiment.

FIG. 2 A diagram showing an example of a functional configuration of the image processing device 100 according to the present embodiment.

FIG. 3 A diagram showing an example of a vehicle interior image and a vehicle exterior image acquired from a vehicle M1.

FIG. 4 An explanatory diagram of a process executed by an image processing unit 130.

FIG. 5 An explanatory diagram of a process executed by an image conversion unit 140.

FIG. 6 A diagram showing an example of time-series vehicle interior images converted by the image conversion unit 140.

FIG. 7 An explanatory diagram of a process executed by an image determination unit 150.

FIG. 8 A diagram showing an example of annotation work executed by an annotator.

FIG. 9 A diagram showing an example of driving assistance using a trained model 180.

FIG. 10 A diagram showing an example of a flow of a process executed by the image conversion unit 140.

FIG. 11 A diagram showing an example of a flow of a process executed by the image determination unit 150.

### DESCRIPTION OF EMBODIMENTS

Hereinafter, embodiments of an image processing device, an image processing method, an image processing system, and a program of the present invention will be described with reference to the drawings.

### Overview

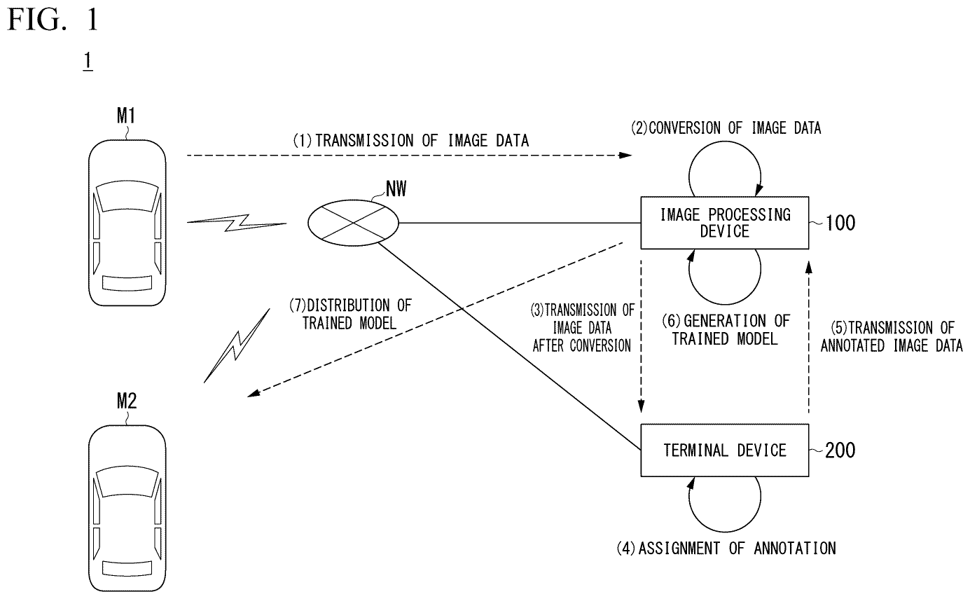

FIG. 1 is a diagram showing an overview of a system 1 including an image processing device 100 according to the present embodiment. As shown in FIG. 1, the system 1 includes at least one or more vehicles M1 and M2, an image processing device 100, and a terminal device 200. Although the vehicle M1 and the vehicle M2 are shown as different vehicles for convenience of description, these vehicles may be the same.

The vehicle M1 is, for example, a four-wheel drive vehicle such as a hybrid vehicle or an electric vehicle, and includes at least a camera configured to capture the interior of the vehicle M1 and a camera configured to capture the exterior of the vehicle M1. During movement, the vehicle M1 transmits a vehicle interior image and a vehicle exterior image captured by these cameras to the image processing device 100 via a network NW such as a cellular network, a Wi-Fi network, or the Internet.

The image processing device 100 is a server device configured to perform image conversion to be described below for received captured image data when the captured image data including the vehicle interior image and the vehicle exterior image is received from the vehicle M1. This image conversion is a process of protecting the privacy of a person shown in the vehicle interior image and the vehicle exterior image. The image processing device 100 transmits converted image data that has been obtained to the terminal device 200 via the network NW.

The terminal device 200 is a terminal device such as a desktop computer or a smartphone. When the converted image data is acquired from the image processing device 100, a user of the terminal device 200 performs annotating work to be described below for the acquired converted image data. When the annotating work is completed, the user of the terminal device 200 transmits annotated image data in which annotations are applied to the converted image data to the image processing device 100.

When the image processing device 100 receives the annotated image data from the terminal device 200, the received annotated image data is used as learning data and any machine learning model is used to generate a trained model to be described below. The trained model is, for example, a behavior prediction model for outputting the predictive behavior (trajectory) of the person shown in the vehicle exterior image with respect to the input of the vehicle exterior image or providing an alert for a pedestrian shown in the vehicle exterior image in consideration of a visual line of a driver shown in the vehicle interior image with respect to the inputs of the vehicle interior image and the vehicle exterior image.

In this case, image data to be used as the learning data may be annotated image data to which annotations are applied to the converted image data or the annotation may be annotated image data obtained by reconverting the converted image data into the captured image data as it is (i.e., annotated image data in which the annotation is applied to the captured image data). By using annotated image data in which annotations are applied to the captured image data as learning data, it is possible to use more realistic learning data from which the influence of image conversion is removed.

When the image processing device 100 generates the trained model, the generated trained model is distributed to the vehicle M2 via the network NW. Like the vehicle M1, the vehicle M2 is, for example, a four-wheel drive vehicle such as a hybrid vehicle or an electric vehicle, and the vehicle M2 obtains behavior prediction data of a person located near the vehicle M2 by inputting at least one of the vehicle interior image and the vehicle exterior image captured by the camera to the trained model during movement. The driver of the vehicle M2 can refer to the obtained behavior prediction data and utilize the obtained behavior prediction data for driving of the vehicle M2. Hereinafter, more detailed content of each process will be described.

### Functional Configuration of Image Processing Device

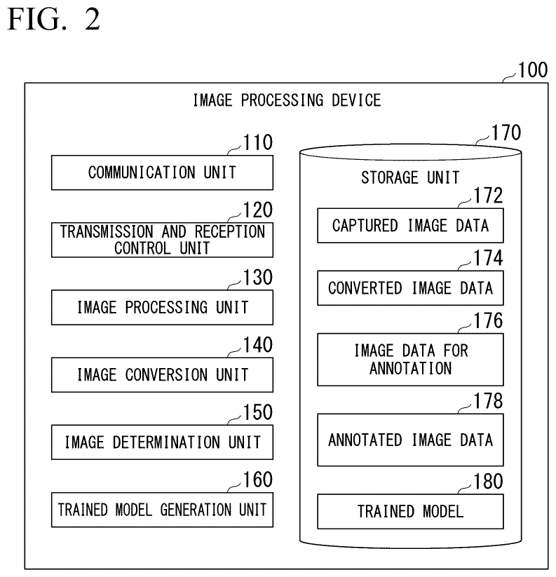

FIG. 2 is a diagram showing an example of a functional configuration of the image processing device 100 according to the present embodiment. The image processing device 100 includes, for example, a communication unit 110, a transmission/reception control unit 120, an image processing unit 130, an image conversion unit 140, an image determination unit 150, a trained model generation unit 160, and a storage unit 170. For example, these components are implemented by a hardware processor such as a central processing unit (CPU) executing a program (software). Also, some or all of these components may be implemented by hardware (including a circuit; circuitry) such as a large-scale integration (LSI) circuit, an application-specific integrated circuit (ASIC), a field-programmable gate array (FPGA), or a graphics processing unit (GPU) or may be implemented by software and hardware in cooperation. The program may be pre-stored in a storage device (a storage device including a non-transitory storage medium) such as a hard disk drive (HDD) or flash memory. The program may be stored in a removable storage medium (a non-transitory storage medium) such as a DVD or a CD-ROM and installed in the storage device 350 when the storage medium is mounted in a drive device. The storage unit 170 is, for example, an HDD, a flash memory, a random-access memory (RAM), and the like. The storage unit 170 stores, for example, captured image data 172, converted image data 174, annotation image data 176, annotated image data 178, and a trained model 180. Although the image processing device 100 includes the trained model generation unit 160 and the storage unit 170 for storing the trained model 180 for ease of description, the function of generating the trained model and the generated trained model may be held by a server device different from the image processing device 100.

The communication unit 110 is an interface for communicating with the communication device 10 of the host vehicle M via the network NW. For example, the communication unit 110 includes a network interface card (NIC), a wireless communication antenna, and the like.

The transmission/reception control unit 120 transmits/receives data to/from the vehicle M1 and the vehicle M2 and the terminal device 200 using the communication unit 110. More specifically, first, the transmission/reception control unit 120 acquires a plurality of vehicle interior and exterior images captured in time series by the cameras mounted on the vehicle M1 from the vehicle M1. The time series in this case is, for example, a time series in which images are captured at predetermined intervals (for example, every second) in one movement cycle from the start to stop of the vehicle M1.

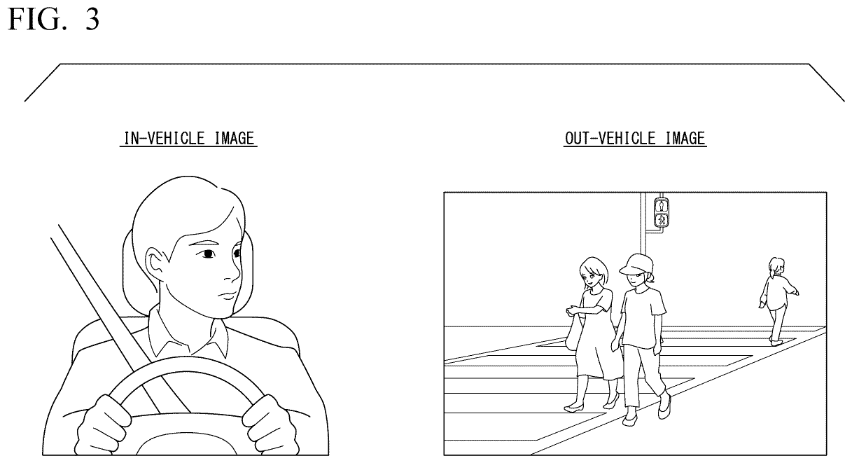

FIG. 3 is a diagram showing an example of the vehicle interior image and the vehicle exterior image acquired from the vehicle M1. The left part of FIG. 3 represents the vehicle interior image acquired from the vehicle M1 and the right part of FIG. 3 represents the vehicle exterior image acquired from the vehicle M1. As shown in the left part of FIG. 3, the vehicle interior image is captured with a camera installed to capture at least the face area of the driver of the vehicle M1. As shown in the right part of FIG. 3, the vehicle exterior image is captured in a state in which the camera is installed so that at least an image of a region in front of the vehicle M1 in a movement direction is captured. The transmission/reception control unit 120 associates the vehicle interior image and the vehicle exterior image acquired from the vehicle M1 with image IDs and stores an association result in the storage unit 170 as the captured image data 172.

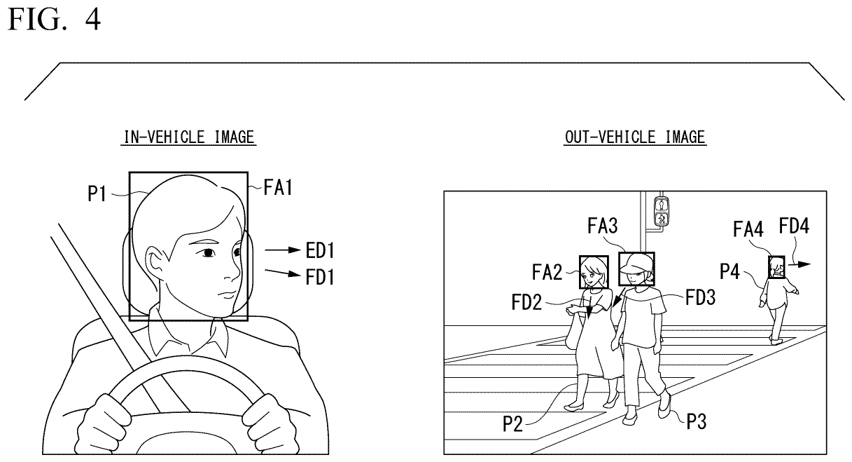

FIG. 4 is an explanatory diagram of a process executed by the image processing unit 130. The image processing unit 130 performs image processing on the captured image data 172 and acquires information such as an image attribute, a face attribute, and a direction of each image included in the captured image data 172. More specifically, when an image is input, the image processing unit 130 acquires an image attribute indicating whether the image is the vehicle interior image or the vehicle exterior image included in the captured image data 172 using a trained model that outputs a classification result indicating whether the image is the vehicle interior image or the vehicle exterior image.

Moreover, when an image is input, the image processing unit 130 acquires a face attribute of each image included in the captured image data 172 using a trained model for outputting a face region, a face size (an area of the face region), and a distance from an image capturing position to a face with respect to all faces included in the image. In FIG. 3, as an example, a face region FA1 of a person P1 is acquired from the vehicle interior image and a face region FA2 of a person P2, a face region FA3 of a person P3, and a face region FA4 of a person P4 are acquired from the vehicle exterior image. Although the face regions FA1, FA2, FA3, and FA4 have been acquired as rectangular regions for convenience, the present invention is not limited to such configurations. For example, a trained model for acquiring a face region along the contour of a person's face may be used.

Furthermore, when an image is input, the image processing unit 130 acquires direction information of a face shown in each image included in the captured image data 172 using a trained model for outputting at least one of the face direction and the visual-line direction, for example, as a vector, with respect to all faces included in the image. More specifically, when the image is input for the image of the captured image data 172 having the attribute of the vehicle interior image, the image processing unit 130 acquires the direction information using a trained model for outputting the face direction and the visual-line direction with respect to all faces included in the image. On the other hand, when the image is input for the image of the captured image data 172 having the attribute of the vehicle exterior image, the image processing unit 130 acquires the direction information using a trained model for outputting the face direction with respect to all faces included in the image. This is because, in general, the face shown in the vehicle interior image is closer to the capturing position than that in the vehicle exterior image and is likely to be largely captured so that the visual-line direction can be extracted. In FIG. 3, as an example, a face direction FD1 and a visual-line direction ED1 of the person P1 are acquired from the vehicle interior image and a face direction FD2 of the person P2, a face direction FD3 of the person P3, and a face direction FD4 of the person P4 are acquired from the vehicle exterior image.

When an image attribute, a face attribute, and direction information are acquired for each image of the captured image data 172, the image processing unit 130 records the image attribute, the face attribute, and the orientation information in association with the image. Although the image processing unit 130 acquires the image attribute, the face attribute, and the orientation information using a trained model as an example in the above description, the present invention is not limited to such a configuration. The image processing unit 130 may acquire the image attribute, the face attribute, and the direction information using any known method.

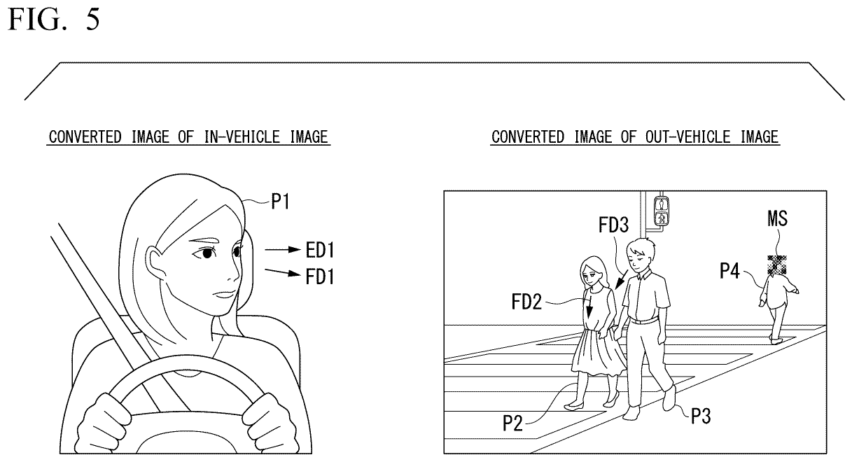

The image conversion unit 140 performs a process of replacing a face of a person with a face of another person without changing the direction information of the person shown in each image with respect to the captured image data 172 processed by the image processing unit 130 using any software in which this function is implemented. FIG. 5 is an explanatory diagram of a process executed by the image conversion unit 140. As shown in FIG. 5, the image conversion unit 140 replaces the faces of the persons P1, P2, and P3 shown in FIG. 4 with faces of other persons without changing the visual-line direction ED1 and the face directions FD1, FD2, and FD3. On the other hand, the face of the person P4 is covered with a mosaic MS as a mosaic processing result of the image conversion unit 140.

That is, the image conversion unit 140 decides whether to replace a face with a face of another person or to perform mosaic processing on the face on the basis of the face attribute of each face shown in each image of the captured image data 172. More specifically, the image conversion unit 140 determines whether or not the size of the face is equal to or greater than a first threshold value Th1 and decides to replace the face with the face of another person when it is determined that the size of the face is equal to or greater than the first threshold value Th1 with respect to each face shown in each image of the captured image data 172. On the other hand, when it is determined that the size of the face is less than the first threshold value Th1, the image conversion unit 140 decides to perform mosaic processing on the face. A process of replacing a face of a person shown in the captured image with a face of another person or performing the mosaic processing on the face is an example of an “anonymization process.”

Moreover, the image conversion unit 140 determines whether or not the distance from the face is equal to or less than a second threshold value Th2 with respect to each face shown in each image of the captured image data 172 and decides to replace the face with a face of another person when it is determined that the distance from the face is equal to or less than the second threshold value Th2. On the other hand, when it is determined that the distance from the face is greater than the second threshold value Th2, the image conversion unit 140 decides to perform mosaic processing on the face. The image conversion unit 140 iteratively executes these determination processes for the number of faces shown in the image and replaces each face with a face of another person or performs mosaic processing on the face according to a determination result. The image conversion unit 140 stores image data obtained by performing such processing on the captured image data 172 in the storage unit 170 as the converted image data 174. Thereby, useful data can be selected as learning data for generating a behavior prediction model, and the privacy of the person shown in each image can be protected when the annotator to be described below performs annotation work.

In addition, it is only necessary to perform at least one of the process of determining whether or not the size of the face is equal to or greater than the first threshold value Th1 and the process of determining whether or not the distance from the face is equal to or less than the second threshold value Th2. When both processes are performed, the image conversion unit 140 may decide to replace the face with a face of another person when the size of the face is equal to or greater than the first threshold value Th1 and the distance from the face is equal to or less than the second threshold value Th2 or may decide to replace the face with a face of another person when the size of the face is equal to or greater than the first threshold value Th1 and the distance from the face is equal to or less than the second threshold value Th2.

Furthermore, the image conversion unit 140 may select a face to be used as learning data by performing mosaic processing on a face whose direction information has not been successfully acquired among the faces shown in each image of the captured image data 172.

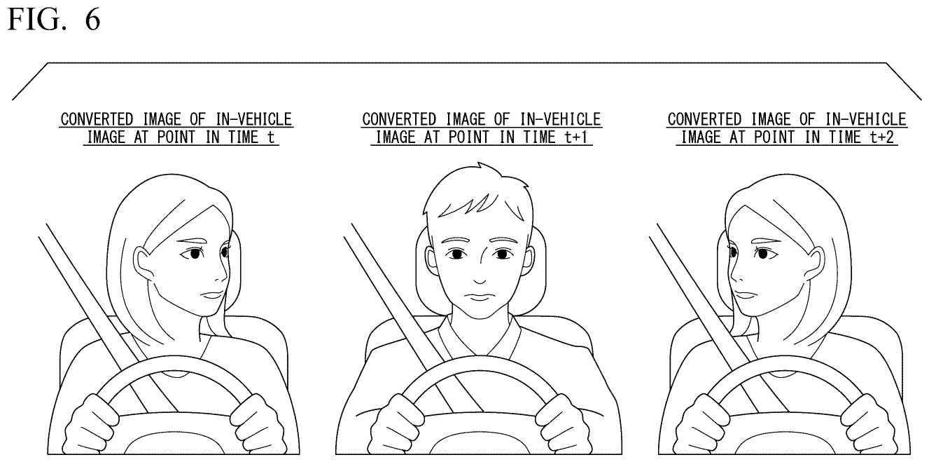

FIG. 6 is a diagram showing an example of time-series vehicle interior images converted by the image conversion unit 140. FIG. 6 shows an example in which the time-series vehicle interior images are converted at three timepoints t, t+1, and t+2. Although these time-series vehicle interior images are obtained by capturing images of the same person and performing face conversion, the face of the same person may be converted into faces of a plurality of different persons according to an operation of face conversion software as shown in FIG. 6. A process using such converted image data as learning data as it is even though the face of the same person is converted into faces of a plurality of different persons is a factor that worsens the accuracy of the behavior prediction model and is not preferable. Therefore, the image determination unit 150 determines the continuity of the time-series vehicle interior and exterior images by executing a process to be described below.

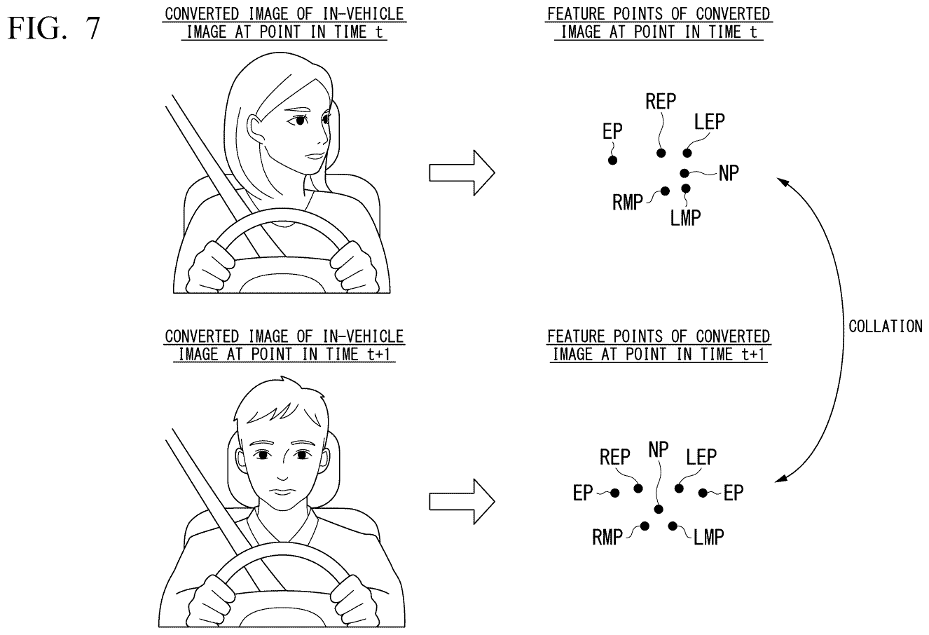

FIG. 7 is an explanatory diagram showing a process executed by the image determination unit 150. As shown in FIG. 7, the image determination unit 150 first extracts a feature point indicating a face from the face of a person shown in a converted image. For example, the image determination unit 150 extracts feature points indicating a right eye REP, a left eye LEP, a nose NP, a right mouth angle RMP, a left mouth angle LMP, and an ear EP from the face of the person shown in the converted image. The image determination unit 150 extracts feature points of the face of the person tracked as the same person from each of the time-series converted images, and compares these feature points. Whether or not the same person has been “tracked” can be determined by, for example, associating the same person captured in the captured images at a stage before the images are converted.

In the case of FIG. 7, the image determination unit 150 extracts the feature points of the person shown in the converted image of the timepoint t and the feature points of the person shown in the converted image of the timepoint t+1. The image determination unit 150 performs a collation process by determining whether or not two sets of extracted feature points are substantially consistent with each other according to translation or rotation.

When it is determined that the extracted feature points are substantially consistent with each other as a collation result, the image determination unit 150 determines that the face of the person tracked as the same person is the face of the same person even after conversion (i.e., there is continuity in the face). On the other hand, when it is determined that the extracted feature points are not substantially consistent with each other as a collation result, the image determination unit 150 determines that the face of the person tracked as the same person is not the face of the same person even after conversion (i.e., there is no continuity in the face). In this case, the image conversion unit 140 performs a conversion process again for the face determined to have no continuity. At this time, the image conversion unit 140 may perform the conversion process again only for the face determined to have no continuity or may perform the conversion process again with respect to all faces of the persons shown in the time-series converted images. Moreover, for example, the image conversion unit 140 may perform mosaic processing on a face determined to have no continuity without performing the conversion process again and exclude the face from a target to be utilized as learning data. Moreover, for example, when a determination result of the image determination unit 150 indicates that the face of a person tracked as the same person is not the face of the same person after conversion (i.e., there is no continuity in the face), the image determination unit 150 may limit the predetermined process to be performed on the time-series converted images, i.e., may exclude the time-series converted images from the target to be used as learning data. Thereby, it is possible to prevent the occurrence of discontinuity due to an unintended operation of the face conversion software.

The image determination unit 150 further inputs the converted image again to the trained model for outputting at least one of the face direction and the visual-line direction and acquires a face direction FD or a visual-line direction ED in the converted image. The image determination unit 150 determines whether or not the face direction FD or the visual-line direction ED of the face is substantially the same as the face direction FD or the visual-line direction ED of the face shown in the captured image before conversion with respect to faces of persons shown in the converted image. As described above, both the face direction FD and the visual-line direction ED are acquired for the vehicle interior image, and the face direction FD is acquired for the vehicle exterior image. Therefore, for the vehicle interior image, the image determination unit 150 determines whether or not the face directions FD and the visual-line directions ED are substantially consistent with each other between the captured image before conversion and the converted image with respect to the vehicle interior image and determines whether or not the face directions FD are substantially consistent with each other between the captured image before conversion and the converted image with respect to the vehicle exterior image. More specifically, for example, the image determination unit 150 calculates an angle difference between a vector indicating the face direction FD in the captured image before conversion and a vector indicating the face direction FD in the converted image and determines that the face directions FD are substantially consistent with each other when the calculated angle difference is equal to or less than a threshold value. The same is true for the visual-line direction ED. The satisfaction of the continuity of the face or the consistency of the orientation information is an example of a “predetermined requirement.”

When it is determined that the face directions FD or the visual-line directions ED are not substantially consistent with each other between the captured image before conversion and the converted image, the image conversion unit 140 performs a conversion process on the captured image again with respect to the faces whose face directions FD or visual-line directions ED are determined not to be substantially consistent with each other. At this time, the image conversion unit 140 may perform the conversion process again only with respect to the faces whose face directions FD or visual-line directions ED are determined not to be substantially consistent with each other or may perform the conversion process again for all faces included in the converted image including the faces whose face directions FD or visual-line directions ED are determined not to be substantially consistent with each other. Moreover, for example, the image conversion unit 140 may perform mosaic processing on faces whose face directions FD or visual-line directions ED are determined not to be substantially consistent with each other without performing the conversion process again, and exclude the faces from the target to be used as learning data. Moreover, for example, when a determination result of the image determination unit 150 indicates that faces whose face directions FD or visual-line directions ED are determined not to be substantially consistent with each other, the image determination unit 150 may limit the predetermined process to be performed on the time-series converted images, i.e., may exclude the time-series converted images from the target to be used as learning data. Thereby, the deterioration of information due to an unintended operation of the face conversion software can be prevented.

In addition, when there are a plurality of faces shown in the converted image (or when the number of faces shown in the converted image is equal to or greater than a predetermined value), a determination process related to the continuity of the converted image and a determination process related to the consistency of the direction information executed by the image determination unit 150 described above may be executed only with respect to a face assumed to have higher importance instead of all faces shown in the converted image. The image determination unit 150 may perform these determination processes only with respect to a face having a face size equal to or greater than a third threshold value Th3 greater than the first threshold value Th1 or only with respect to a face having a distance from the face equal to or less than a fourth threshold value Th4 less than the second threshold value Th2 in the captured image before conversion as an example of the face assumed to have the higher importance. Moreover, for example, the image determination unit 150 may assume that the face of a person in front of the vehicle M1 in a movement direction or the face of a person whose face direction is facing forward in a movement direction of the vehicle M1 is more important in the captured image before conversion and execute these determination processes. Moreover, for example, when continuity or consistency has been denied for a certain face shown in the converted image, a reconversion process may be executed for a relevant face and a face assumed to have high importance.

When the continuity and consistency of the time-series converted images are confirmed, the image determination unit 150 stores the converted image data 174 confirmed to be continuous and consistent in the storage unit 170 as the annotation image data 176. At this time, the converted image data 174 may be stored in the storage unit 170 as the annotation image data 176 together with information indicating the purpose of use, for example, together with information indicating annotation image data for generating a behavior prediction model for predicting the behavior of a person shown in the input image. The transmission/reception control unit 120 transmits the annotation image data 176 to the terminal device 200. The annotator, who is a user of the terminal device 200, generates annotated image data by performing annotation work on the annotation image included in the annotation image data 176 that has been received and transmits the generated annotated image data to the image processing device 100. The image processing device 100 stores the received annotated image data in the storage unit 170 as annotated image data 178.

In addition, it is only necessary to execute at least one of the determination process related to the continuity of the converted images and the determination process related to the consistency of face direction information executed by the image determination unit 150 described above. When at least one of the continuity and the consistency is satisfied, the converted image data 174 may be stored in the storage unit 170 as the annotation image data 176.

Furthermore, for example, when there are missing images in time-series captured images (or their converted images) obtained at predetermined intervals (e.g., every second) in one movement cycle due to a camera malfunction or the like, the image determination unit 150 does not need to store all of these time-series images in the storage unit 170 as the annotation image data 176.

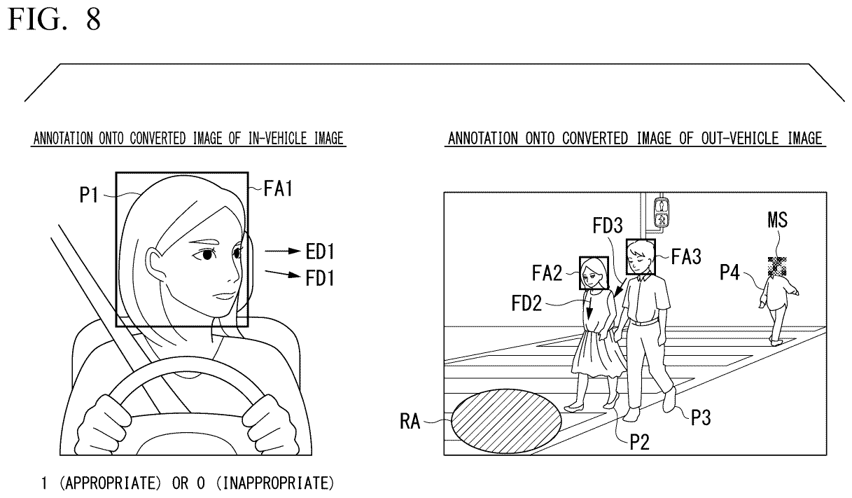

FIG. 8 is a diagram showing an example of annotation work performed by the annotator. The left part of FIG. 8 indicates an annotation for a converted image from a vehicle interior image and the right part of FIG. 8 indicates an annotation for a converted image from a vehicle exterior image. For example, the annotator assigns information indicating whether or not the visual-line direction ED1 of the driver shown in the converted image is appropriate in a situation shown in the converted image from the vehicle exterior image at the same time (for example, assigns 1 if appropriate or assigns 0 if inappropriate) to the converted image from the vehicle interior image. For example, in the case of FIG. 8, the converted image from the vehicle exterior image indicates that there is a pedestrian on the left side of the vehicle movement direction, while the converted image from the vehicle interior image indicates that the visual line of the driver is directed in the left direction. In other words, because it is assumed that the driver is paying appropriate attention to the pedestrian, the annotator assigns information (i.e., 1) indicating that the driver's visual-line direction ED1 is appropriate.

Furthermore, the annotator designates a risk region RA where a person shown in the converted image is predicted to move, for example, in a state in which a person to which mosaic processing is applied is excluded, with respect to the converted image from the vehicle exterior image. Because the face of the person shown in the original image is converted into a face of another person according to processes of the image conversion unit 140 and the image determination unit 150, the privacy of the person is protected. At the same time, because the face direction and the visual-line direction of the person are maintained even after the conversion, the annotator can accurately designate the risk region RA with reference to the face direction and the visual-line direction of another person shown in the converted image. Thereby, it is possible to generate learning data effective for training machine learning models while protecting the privacy of the person shown in the face image.

When the annotated image data 178 is stored in the storage unit 170, the trained model generation unit 160 uses the annotated image data 178 as learning data and generates a trained model using any machine learning model. As described above, this trained model is, for example, a behavior prediction model for outputting the predictive behavior (trajectory) of the person shown in the vehicle exterior image with respect to the input of the vehicle exterior image and providing an alert for the pedestrian shown in the vehicle exterior image in consideration of the visual line of the driver shown in the vehicle interior image with respect to the inputs of the vehicle interior image and the vehicle exterior image. The trained model generation unit 160 stores the generated trained model in the storage unit 170 as the trained model 180.

When the trained model 180 is generated, the transmission/reception control unit 120 distributes the generated trained model 180 to the vehicle M2 via the network NW. When the trained model 180 is received, the vehicle M2 uses the trained model 180 (more precisely, an application program utilizing the trained model 180) to provide driving assistance to the driver of the vehicle M2.

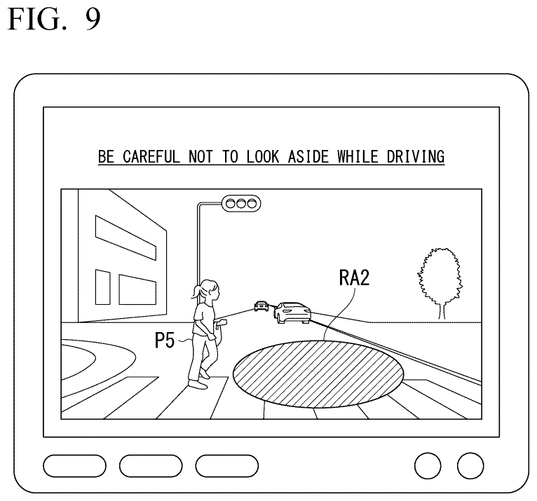

FIG. 9 is a diagram showing an example of driving assistance using the trained model 180. FIG. 9 shows an example in which the vehicle M2 inputs a vehicle interior image and a vehicle exterior image captured by a camera mounted thereon to the trained model 180 during movement and the trained model 180 provides the driving assistance by outputting information for providing an alert to a pedestrian shown in the vehicle exterior image to a human machine interface (HMI) in consideration of a visual line of the driver shown in the vehicle interior image. As shown in FIG. 9, for example, the HMI displays a risk region RA2 corresponding to a pedestrian P5 shown in the vehicle exterior image and a warning message (“Please be careful of distracted driving”) is output as text information or audio information when the visual line of the driver shown in the vehicle interior image is not directed toward the pedestrian P5. Thereby, driving assistance that takes into account the driver's state can be implemented.

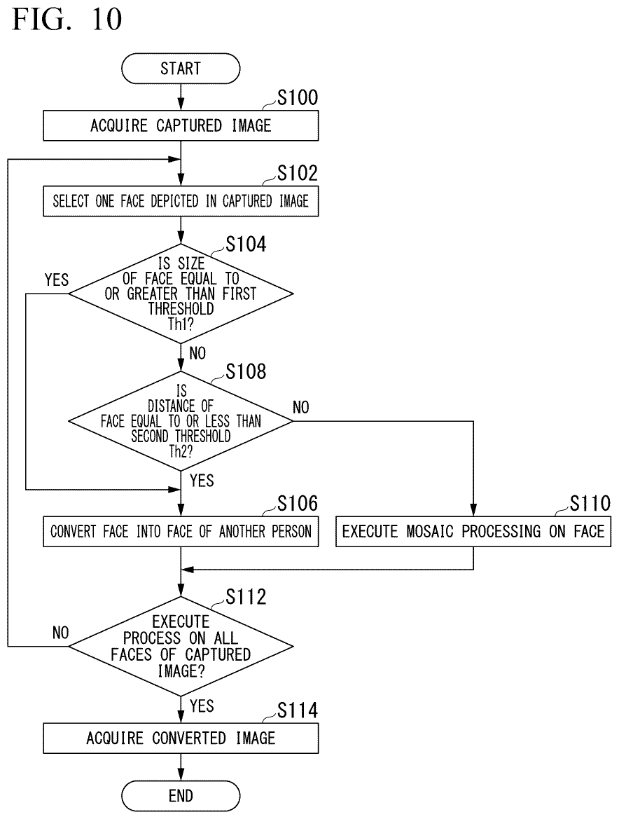

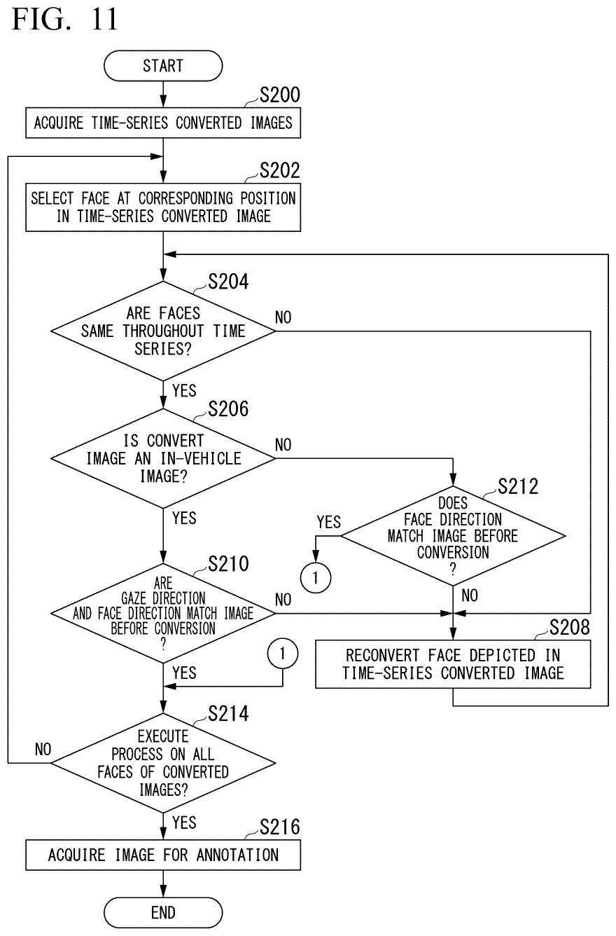

Next, a flow of a process executed by the image processing device 100 will be described with reference to FIGS. 10 and 11. FIG. 10 is a diagram showing an example of the flow of the process executed by the image conversion unit 140. The process shown in FIG. 10, for example, is executed at a timing when a vehicle interior image or a vehicle exterior image is captured by a camera mounted on the vehicle M1 and a process of the image processing unit 130 is performed.

First, the image conversion unit 140 acquires a captured image included in the captured image data 172 on which the process of the image processing unit 130 has been performed (step S100). Subsequently, the image conversion unit 140 selects one face shown in the acquired captured image (step S102).

Subsequently, the image conversion unit 140 determines whether or not the size of the selected face is equal to or greater than the first threshold value Th1 (step S104). When it is determined that the size of the selected face is equal to or greater than the first threshold value Th1, the image conversion unit 140 converts the selected face into a face of another person (step S106). On the other hand, when it is determined that the size of the selected face is less than the first threshold value Th1, the image conversion unit 140 subsequently determines whether or not the distance from the selected face is equal to or less than the second threshold value Th2 (step S108).

When it is determined that the distance from the selected face is equal to or less than the second threshold value Th2, the image conversion unit 140 proceeds to step S106 and converts the selected face into a face of another person. On the other hand, when it is determined that the distance from the selected face is greater than the second threshold value Th2, the image conversion unit 140 performs mosaic processing on the face (step S110). Subsequently, the image conversion unit 140 determines whether or not the processing has been performed on all faces shown in the acquired captured image (step S112).

When it is determined that the processing has been performed on all faces shown in the acquired captured image, the image conversion unit 140 acquires an image obtained by performing the processing on all faces as a converted image and stores the acquired image in the storage unit 170 as the converted image data 174 (step S114). On the other hand, when it is determined that the processing has not been performed on all the faces shown in the acquired captured image, the image conversion unit 140 returns the process to step S102. Thereby, the process of the present flowchart ends.

FIG. 11 is a diagram showing an example of a flow of a process executed by the image determination unit 150. The process shown in FIG. 11, for example, is executed at a timing in which time-series converted images are obtained by performing the above-described conversion process on time-series captured images captured in one movement cycle from the start to stop of the vehicle M1.

First, the image determination unit 150 acquires time-series converted images (step S200). Subsequently, the image determination unit 150 selects a face of a person tracked as the same person before conversion in the acquired time-series converted images (step S202).

Subsequently, the image determination unit 150 determines whether or not the faces are the same even after conversion by extracting feature points from the face of the person tracked as the same person before conversion from each of the time-series converted images and performing a collation process (step S204). When it is determined that the faces are the same even after conversion, the image determination unit 150 subsequently determines whether or not the acquired time-series converted images are vehicle interior images (step S206). On the other hand, when it is determined that the faces are not the same, the image determination unit 150 causes the image conversion unit 140 to reconvert the face of the person tracked as the same person before conversion in the time-series captured images (step S208). Subsequently, the image determination unit 150 executes the processing of step S204 on the converted face again.

In step S206, when it is determined that the acquired time-series converted images are vehicle interior images, the image determination unit 150 determines whether or not visual-line directions and face directions of these faces are consistent with those of the image before conversion (step S210). On the other hand, when it is determined that the acquired time-series converted images are not vehicle interior images, i.e., are vehicle exterior images, the image determination unit 150 determines whether or not the face directions of these faces are consistent with those of the image before conversion (step S212). When it is determined that there is no consistency in the processing of step S210 or step S212, the image determination unit 150 moves the process to step S208.

When it is determined that there is consistency in the processing of step S210 or step S212, the image determination unit 150 determines that these faces have been successfully converted and determines whether or not the processing has been executed on all faces shown in the time-series converted images (step S214). When it is determined that the processing has been executed on all faces shown in the time-series converted images, the image determination unit 150 acquires these time-series converted images as annotation images and causes the transmission/reception control unit 120 to transmit the acquired annotation images to the terminal device 200 (step S216). On the other hand, when it is determined that the processing has not been executed on all faces shown in the time-series converted images, the image determination unit 150 returns the process to step S202. Thereby, the process of the present flowchart ends.

According to the above-described present embodiment, a predetermined process is performed on a plurality of input images on which an anonymization process has been performed when it is determined that a plurality of input images on which the anonymization process has been performed satisfy a predetermined requirement. The anonymization process includes a process of changing faces of persons shown in the plurality of input images to faces of other persons. The predetermined requirement includes that the face of a person tracked as the same person shown in the plurality of input images on which the anonymization process has been performed is the face of the same person after the anonymization process. That is, in the present embodiment, the face belonging to the same person before the anonymization process is guaranteed to be the face of the same person even in the anonymization process and is used as learning data. Thereby, it is possible to generate learning data effective for training machine learning models while protecting the privacy of the person shown in the face image.

Moreover, according to the present embodiment, the predetermined requirement includes that direction information of the face of a person tracked as the same person shown in a plurality of input images is consistent with direction information of the face of the same person shown in the plurality of input images on which an anonymization process has been performed. That is, in the present embodiment, the direction information of the face of the same person is guaranteed to be unchanged even if the anonymization process is performed. Thereby, it is possible to generate learning data effective for training machine learning models while protecting the privacy of the person shown in the face image.

Moreover, according to the present embodiment, the predetermined requirement is determined in accordance with an image attribute that is a capturing aspect of a plurality of input images. That is, in the present embodiment, a predetermined process that is a process of saving it as learning information for generating a behavior prediction model is executed, for example, in consideration of a capturing aspect of each of the plurality of input images. Thereby, it is possible to generate learning data effective for training machine learning models while protecting the privacy of the person shown in the face image.

Furthermore, according to the present embodiment, it is determined whether to perform an anonymization process based on a first method or an anonymization process based on a second method different from the first method on the basis of a size of a face shown in each of the plurality of input images or a distance from a capturing point to the face. That is, in the present embodiment, a method of an anonymization process performed on a face changes according to whether or not it is useful for training the machine learning model. Thereby, it is possible to generate learning data effective for training machine learning models while protecting the privacy of the person shown in the face image.

### Modified Example

As described above, in the present embodiment, an example in which, when it is determined that the face shown in the converted image does not satisfy the predetermined requirement, the image determination unit 150 reconverts the converted image or performs mosaic processing has been described. However, when the image determination unit 150 determines that the predetermined requirement is not satisfied, the image determination unit 150 does not perform a predetermined process on the converted image, i.e., performs a process of limiting the predetermined process (preventing image storage, transmission to the server, or the like).

Furthermore, in the present embodiment, an example in which the image processing device 100 is implemented as a server device separate from the vehicle M1 has been described. However, as a modified example of the present embodiment, the image processing device 100, more specifically, a device having at least the functions of the image processing unit 130, the image conversion unit 140, and the image determination unit 150 may be mounted on the vehicle M1 as an in-vehicle device. In this case, the in-vehicle device performs the above-described process of the image processing unit 130 for the image captured by the in-vehicle camera, performs an anonymization process of the image conversion unit 140, and performs a determination process of the image determination unit 150. Thereafter, the in-vehicle device transmits an anonymized image obtained by the image determination unit 150 confirming the continuity of the face and the consistency of the direction information to an external image server.

When the anonymized image is received from the vehicle M1, the image server stores the received anonymized image as annotation image data in the storage unit and transmits the annotation image data to the terminal device 200 of the annotator or permits the terminal device 200 to access the annotation image data. When annotated image data is received from the terminal device 200, the image server generates a trained model 180 based on the annotated image data and distributes the trained model 180 that has been generated to the vehicle M2. In this way, as in the present embodiment, it is possible to generate learning data effective for training machine learning models while protecting the privacy of the person shown in the face image. Furthermore, according to the present modified example, because the in-vehicle device performs an anonymization process on the image and then transmits an anonymized image to the image server, the privacy of the person shown in the face image can be further reliably protected.

Furthermore, as another aspect, the in-vehicle device includes only some of the functions of the image processing unit 130, the image conversion unit 140, and the image determination unit 150, and the image server may have the remaining functions. For example, the in-vehicle device may include the functions of the image processing unit 130 and the image conversion unit 140 and the image server may include the functions of the image determination unit 150 or the in-vehicle device may include the functions of the image processing unit 130 and the image server may include the functions of the image conversion unit 140 and the image determination unit 150.

The embodiment described above can be represented as follows.
An image processing device including:
a storage medium storing computer-readable instructions; and
a processor connected to the storage medium, the processor executing the computer-readable instructions to:
acquire a size of a face shown in an input image or a distance from a capturing point of the input image to the face;
perform an anonymization process on the input image; and
decide to perform the anonymization process based on a first method or the anonymization process based on a second method different from the first method on the face shown in the input image on the basis of the size or the distance.

Although modes for carrying out the present invention have been described above using embodiments, the present invention is not limited to the embodiments and various modifications and substitutions can also be made without departing from the scope and spirit of the present invention.

### REFERENCE SIGNS LIST

100 Image processing device
110 Communication unit
120 Transmission/reception control unit
130 Image processing unit
140 Image conversion unit
150 Image determination unit
160 Trained model generation unit
170 Storage unit
172 Captured image data
174 Converted image data
176 Annotation image data
178 Annotated image data
180 Trained model

What is claim is:

1. An image processing device comprising:
an acquisition unit configured to acquire a size of a face shown in an input image or a distance from a capturing point of the input image to the face; and
an image conversion unit configured to perform an anonymization process on the input image,
wherein the image conversion unit decides to perform the anonymization process based on a first method or the anonymization process based on a second method different from the first method on the face shown in the input image on the basis of the size or the distance.

2. The image processing device according to claim 1, further comprising an image determination unit configured to determine whether or not the input image on which the anonymization process has been performed satisfies a predetermined requirement and perform a predetermined process on the input image on which the anonymization process has been performed when it is determined that the input image on which the anonymization process has been performed satisfies the predetermined requirement.

3. The image processing device according to claim 2, wherein the predetermined process is a process of saving the input image on which the anonymization process has been performed as an annotation work target image.

4. The image processing device according to claim 2, wherein the predetermined process is a process of saving the input image on which the anonymization process has been performed as learning information for generating a behavior prediction model for predicting behavior of a person shown in the input image.

5. The image processing device according to claim 2, wherein the predetermined process is a process of transmitting the input image on which the anonymization process has been performed to an image server through a communication means.

6. The image processing device according to claim 1, wherein the anonymization process based on the first method is a process of concealing a face shown in the input image and the anonymization process based on the second method is a process of changing a face of a person shown in the input image to a face of another person.

7. The image processing device according to claim 6,
wherein the acquisition unit further acquires direction information about the face of the person shown in the input image, and
wherein the image conversion unit performs the anonymization process based on the first method on the face of the person shown in the input image when the acquisition of the direction information by the acquisition unit has failed.

8. The image processing device according to claim 6,
wherein the acquisition unit further acquires direction information about the face of the person shown in the input image, and
wherein the image conversion unit performs the anonymization process based on the first method on the face of the person shown in the input image when the direction information about the face of the person shown in the input image is not consistent with direction information about the face of the person shown in the input image on which the anonymization process based on the second method has been performed.

9. The image processing device according to claim 6, wherein the image conversion unit performs the anonymization process based on the second method on a plurality of input images captured in time series and performs the anonymization process based on the first method on a face of a person shown in the plurality of input images when the face of the person tracked as the same person in the plurality of input images is not the same face in the plurality of input images on which the anonymization process has been performed.

10. The image processing device according to claim 2, wherein the image conversion unit performs the anonymization process based on the second method on the input image again when the image determination unit determines that the input image on which the anonymization process has been performed does not satisfy the predetermined requirement.

11. The image processing device according to claim 2, wherein the image conversion unit does not perform the predetermined process on the input image on which the anonymization process has been performed when the image determination unit determines that the input image on which the anonymization process has been performed does not satisfy the predetermined requirement.

12. The image processing device according to claim 2, wherein the predetermined requirement differs according to whether the input image is an image obtained by capturing an interior of a vehicle equipped with a camera that has captured the input image or an image obtained by capturing an exterior of the vehicle.

13. An image processing system comprising:
an acquisition unit configured to acquire a size of a face shown in an input image or a distance from a capturing point of the input image to the face; and
an image conversion unit configured to perform an anonymization process on the input image,
wherein the image conversion unit decides to perform the anonymization process based on a first method or the anonymization process based on a second method different from the first method on the face shown in the input image on the basis of the size or the distance.

14. An image processing method comprising:
acquiring, by a computer, a size of a face shown in an input image or a distance from a capturing point of the input image to the face;
performing, by the computer, an anonymization process on the input image; and
deciding, by the computer, to perform the anonymization process based on a first method or the anonymization process based on a second method different from the first method on the face shown in the input image on the basis of the size or the distance.

15. A non-transitory computer-readable storage medium having stored thereon a program for causing a computer to:
acquire a size of a face shown in an input image or a distance from a capturing point of the input image to the face;
perform an anonymization process on the input image; and
decide to perform the anonymization process based on a first method or the anonymization process based on a second method different from the first method on the face shown in the input image on the basis of the size or the distance.
